(19) United States
(12) Patent Application Publication
(10) Pub. No.: US 2026/0088032 A1
(43) Pub. Date: Mar. 26, 2026

(54) PERSONALIZED DEEPFAKE DETECTION

(71) Applicant: Intel Corporation, Santa Clara, CA (US)

(72) Inventors: Jose Lopez, Arlington, MA (US); Georg Stemmer, Munich (DE)

(73) Assignee: Intel Corporation, Santa Clara, CA (US)

(21) Appl. No.: 19/398,581

(22) Filed: Nov. 24, 2025

(51) Int. Cl. G10L 17/06; G06F 21/32; G10L 17/02; G10L 17/18; G10L 25/45

(52) U.S. Cl. CPC G10L 17/06; G06F 21/32; G10L 17/02; G10L 17/18; G10L 25/45

(57) ABSTRACT

Systems and methods are provided for detecting audio deepfakes, including synthetic speech generated using advanced artificial intelligence techniques. The disclosed techniques address the shortcomings of existing deepfake detection models, which often fail to robustly distinguish between authentic and synthetic audio and may require extensive retraining or large datasets. The deepfake detection system leverages verified audio samples of a known speaker to generate a distribution of detection scores using a speaker-independent deepfake detector, without modifying or retraining the underlying model. By segmenting the verified samples and constructing a statistical reference distribution, the system applies a statistical test to determine whether the detection scores from an unverified audio input are consistent with the reference distribution. This allows for accurate and efficient personalized deepfake detection, incorporating speaker-specific conditioning information without model retraining, and the resulting system is compatible with real-time applications.

### TECHNICAL FIELD

This disclosure relates generally to deepfake detection, and in particular to techniques for detecting synthetic audio.

### BACKGROUND

The proliferation of artificial intelligence technologies has enabled the creation of highly realistic synthetic audio, commonly referred to as audio deepfakes. Audio deepfakes pose significant risks to data security, privacy, and the integrity of communications, as they can be used for fraud, misinformation, impersonation, and other malicious activities. However, detection of deepfakes is challenging, particularly as artificial intelligence models are increasingly capable of generating speech that closely mimics natural human voices. While these models can leverage verified samples of a reference speaker, they are generally outperformed by deepfake detection models that focus on identifying anomalies or artifacts introduced by speech synthesis algorithms. However, none of these models can reliably detect audio deepfakes.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 shows a deepfake detection system 100, according to various embodiments.

FIG. 2 illustrates an example of a deepfake detector that can be used in the deepfake detection system, according to various embodiments.

FIGS. 3A-3B illustrate tables showing a distribution of deepfake detection scores for selected speakers, in accordance with various embodiments.

FIG. 4 shows a table illustrating the results of statistical hypothesis testing on speaker-specific deepfake score distributions for multiple speakers, in accordance with various embodiments.

FIG. 5 shows a flowchart illustrating an example method of deepfake detection, in accordance with various embodiments.

FIG. 6 is a block diagram of an example deep learning system, in accordance with various embodiments.

FIG. 7 is a block diagram of an example computing device, in accordance with various embodiments.

### DESCRIPTION

### Overview

Systems and methods are provided for detecting audio deepfakes. In particular, techniques are provided for identifying synthetic speech generated using advanced artificial intelligence techniques. Audio deepfakes can be exploited for fraud, misinformation, and other malicious purposes, posing significant risks to security and trust in digital communications. Audio deepfake detection, also known as audio spoofing detection, can protect users from fraud and/or misinformation. Existing deepfake detection models, which are generally designed to identify anomalies or artifacts introduced during speech synthesis, often fail detect audio deepfakes. In general, deepfake detection models often fail to provide robust performance when distinguishing between authentic and synthetic audio for a specific individual.

One approach to detecting deepfakes includes the use of speaker recognition models to compare audio samples and determine whether both samples originate from the same speaker. However, speaker recognition models are generally outperformed by deepfake detection systems that focus on speech synthesis-related distortions. Other deepfake detection approaches involve retraining and/or fine-tuning deepfake detection models to incorporate deepfake conditioning information, which requires substantial computational resources and large datasets. These approaches are impractical for real-time deployment and do not scale efficiently across diverse speakers or languages. Thus, current approaches fail to accurately detect deepfakes or impose prohibitive costs in terms of data collection and model retraining.

Systems and methods are provided herein for accurate detection of deepfakes. In particular, the systems and methods incorporate verified samples of a known speaker in the decision-making process, thereby increasing the accuracy of the detector. The techniques provide a method for personalized deepfake detection that leverages verified audio samples of a known speaker without modifying or retraining the underlying deepfake detection model. The deepfake detection system includes generating a distribution of detection scores for the verified samples by segmenting the audio into smaller frames and applying an inference step of a speaker-independent deepfake detector. Using the generated detection scores, the system can construct a statistical reference distribution for the known speaker. The systems and methods can perform an evaluation, including applying a statistical test to determine whether the scores from a test audio file belong to the same distribution as the verified samples, and determine whether to classify the test file as a deepfake. The technique enables the incorporation of speaker-specific conditioning information into a deepfake detection framework, thereby increasing deepfake detection accuracy without retraining the model for each speaker. The systems and methods presented herein are computationally efficient and compatible with real-time applications.

### Example Deepfake Detection System

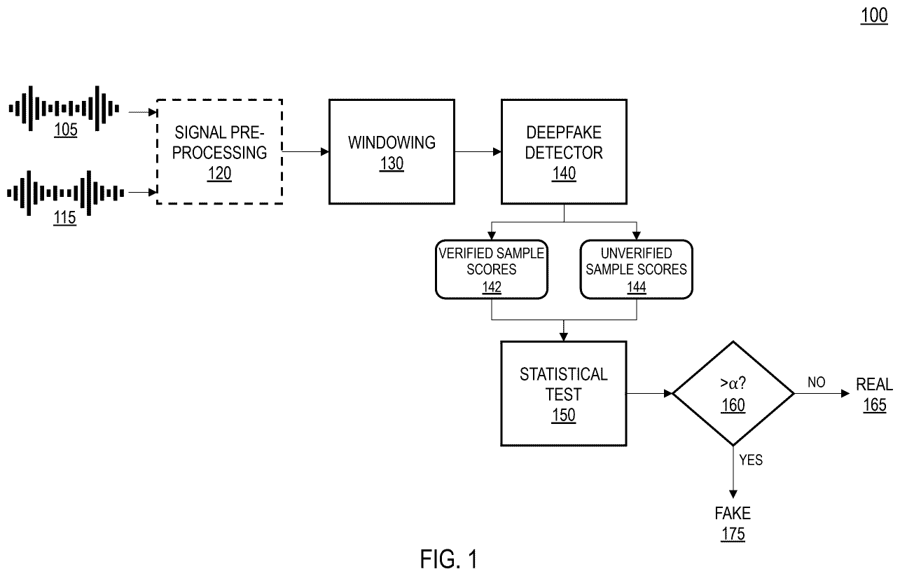

FIG. 1 shows a deepfake detection system 100, according to various embodiments. In particular, the system 100 receives two audio input samples: an unverified input audio sample 105 and one or more verified audio samples 115. The verified audio samples 115 can include multiple verified audio samples associated with a selected known speaker. The unverified input audio sample 105 can be a test audio sample to be evaluated by the deepfake detection system 100. In various implementations, the deepfake detection system 100 leverages multiple verified audio samples 115 of the selected known speaker to generate a population of deepfake detection scores for the verified samples, which can be used to increase deepfake detection accuracy for the unverified input audio sample 105. In various examples, the verified samples 115 may be sourced from curated datasets, including, for instance, proprietary collections and public corpora. In some examples, the curated datasets can be augmented to increase diversity and robustness.

The unverified input audio sample 105 and one or more verified audio samples 115 can be received at an optional signal pre-processing block 120. The signal pre-processing block 120 preprocesses the unverified input audio sample 105 and the one or more verified audio samples 115 to normalize the input samples. Pre-processing can include filtering, signal standardization, mean subtraction, noise reduction, resampling, feature extraction, and/or other pre-processing operations. In some examples, the signal pre-processing block 120 applies bandpass filtering to the input audio samples 105, 115 to filter out non-speech frequencies. In some examples, the signal pre-processing block 120 applies signal standardization and bandpass filtering to mitigate the influence of spectral content outside the 0.3 kHz to 3.4 kHz band. Feature extraction can be performed by a speech foundation models, such as Wav2Vec2, WaveLM, or Whisper. According to various examples, feature extractors generally output several embeddings proportional to the length of the input. After extracting features, the embeddings may be pooled before passing through a classifier head to estimate the likelihood of being fake

The input signals are input to a windowing module 130. The input to the windowing module can be pre-processed or the input can be the input audio samples 105, 115. In various examples, the input samples are segmented, for instance using sliding windows. In particular, at the windowing module 130, the pre-processed verified input samples are segmented into smaller units. In some examples, the pre-processed verified input samples are segmented using a sliding window. The sliding window may have overlapping frames to capture temporal variations. In some examples, the pre-processed verified input samples are segmented into a plurality of windows using a window duration between 2 seconds and 5 seconds and a hop size between 0.25 seconds and 1.0 second. In one example, an audio clip can be windowed using a 3.5 s window size with a 1.75 s overlap. In some examples, having shorter step sizes (i.e., more overlap) results in more segments. In some examples, the having a greater number of segments can result in reduced latency in identifying fake segments, but can also increase computation cost since there are more segments to process. Accuracy of deepfake detection can increase with greater numbers of segments. In some examples, smaller window sizes can result in reduced latency but less accurate detection performance.

In some examples, the segmented samples can be augmented using data augmentation strategies. According to some implementations, augmentation can be used to create a larger population of inferences for the verified samples. In some examples, augmentations are applied probabilistically to increase the diversity of the sample population and improve model generalization. In particular, augmentation of the windows involves the application of various transformations to the segmented audio, thereby artificially increasing both the diversity and the quantity of data available for subsequent analysis. Such transformations may include the injection of background noise at varying signal-to-noise ratios, modification of temporal characteristics by speeding up or slowing down the signal without altering its pitch, adjustment of pitch, application of different audio codecs to simulate real-world distortions, simulation of diverse acoustic environments through convolution with room impulse responses, and alteration of the sample rate followed by restoration to the original rate. Data augmentation strategies can include additive white Gaussian noise (AWGN), telephony distortion, codec compression, room impulse response (RIR) augmentation, resampling, time stretching, pitch shifting, and so on.

According to various implementations, augmenting the windows can serve to generate multiple variations of each segment, generating various distinguishing features of authentic and synthetic audio across a broad spectrum of conditions. This process can enhance the model's robustness to variations in audio quality, background noise, and recording environments, thereby supporting reliable operation in real-world scenarios. By creating a larger and more varied population of inference scores, the system facilitates more reliable statistical testing and improves the accuracy of person-specific authenticity assessments. Additionally, augmentation techniques can emulate the variability inherent in practical audio acquisition, including differences in microphones, environments, and transmission channels. According to some examples, the windowing module 130 generates a sufficiently large set of segments for robust statistical modeling.

A deepfake detector 140 can receive the segments from the windowing module 130. The deepfake detector 140 can be a pretrained, speaker-independent deepfake detection model. The deepfake detector 140 is applied to each segment to determine a detection score indicative of authenticity of the segment. In some examples, the deepfake detector 140 can include a model that may utilize a self-supervised backbone (e.g., Wav2Vec2 (Waveform-to-Vector 2), WavLM (Waveform-based Language Model), Whisper) and a classifier head. In some examples, the classifier head can be fully connected. For verified samples 115, the scores 142 generated by the deepfake detector 140 collectively form a person-specific score reference distribution. For the unverified input audio sample 105 segments, one or more scores 144 are generated for comparison against the reference distribution. In some examples, the deepfake detector 140 evaluates whether the null hypothesis can be rejected or not (i.e., the hypothesis that the scores 144 obtained from the unverified input audio sample 105 belong to the same distribution as the scores 142 collected from the verified input audio samples 115). In some examples, the technique allows for the use of conditioning information in deepfake detection models that were not explicitly trained to utilize conditioning information. In some examples, the deepfake detector 140 may utilize temporal average pooling and calibrated prediction techniques (e.g., Platt calibration) to further refine the output scores.

The output from the deepfake detector 140 (verified sample scores 142 and unverified sample scores 144) is input to a statistical test block 150. The statistical test block 150 performs a statistical test to evaluate whether the scores 144 for the unverified input audio sample 105 originate from the same distribution as the scores 142 for the verified input audio samples 115. The null hypothesis asserts that both sets of scores (the scores 144 for the unverified input audio sample 105 and the scores 142 for the verified input audio samples 115) belong to the same statistical population. Distribution estimation may include histogram computation or fitting a parametric model, such as a Gaussian distribution. In some examples, the statistical test block 150 determines a metric representing the statistical distance between the two sets of scores, which is compared against a predefined distance threshold. In some examples, the statistical test block 150 determines a metric representing the likelihood the scores 144 for the unverified input audio sample 105 belong to the same statistical population as the scores 142 for the verified input audio samples 115. In some examples, the statistical test block 150 may utilize threshold-independent metrics (e.g., equal-error-rate, area under the curve) and/or threshold-dependent metrics (e.g., accuracy, F1-score) to assess performance.

The output from the statistical test block 150 is input to a decision logic block 160, which determines if the metric calculated by the statistical test block 150 exceeds a selected threshold T. If the metric calculated by the statistical test block 150 exceeds the selected threshold T, the null hypothesis is rejected, and the unverified input audio sample 105 is classified as inauthentic (i.e., fake) at 175. If the metric calculated by the statistical test block 150 is equal to or less than the selected threshold T, the unverified input audio sample 105 is classified as authentic at 165.

In one example, the scores 142 for the verified input audio samples 115 are determined to be {0.1, 0.2, 0.15, 0.07, 0.03, 0.11}, and the score 144 for the unverified input audio sample 105 is 0.52. In this example, the scores 142 for the verified input audio samples 115 exhibit a Gaussian distribution with a mean of 0.11 and a standard deviation of 0.06. Thus, the score 144 for the unverified input audio sample 105 is significantly greater than the mean score of the Gaussian distribution of the verified samples, exceeding six standard deviations from the mean. Therefore, it is likely that the unverified input (i.e., the test clip) is inauthentic. Thus, the deepfake detection system 100 determines that the unverified input audio sample 105 is inauthentic.

In another example, the scores 142 for the verified input audio samples 115 are determined to be {0.1, 0.2, 0.15, 0.07, 0.03, 0.11} (the same as above), and the scores 144 for the unverified input audio sample 105 are {0.52, 0.57, 0.53}. In this example, again, the scores 144 for the unverified input audio sample 105 are significantly greater than the mean score of the Gaussian distribution of the verified samples, exceeding six standard deviations from the mean. In some examples, the p-value for the t-score can be determined. The t-score in this case equals 28.15, which has a p-value of 0.001, which is considered significant since it is less than the significance level of 0.05. Therefore, it is likely that the test clip is inauthentic. Thus, the deepfake detection system 100 determines that the unverified input audio sample 105 is inauthentic.

In other examples, other statistical tests can be used to compare the verified samples with the unverified sample. For instance, a chi-square test can be used for the comparison. Additionally, the threshold can be adjusted based on a user's selected false-positive versus false-negative operating point.

Note that in traditional deepfake detection models, no verified samples are used. Thus, the model generates a score and decide whether the score indicates a likelihood of the input sample being fake based on whether the score is greater than or less than a threshold. However, the score is never compared to a score for a verified sample.

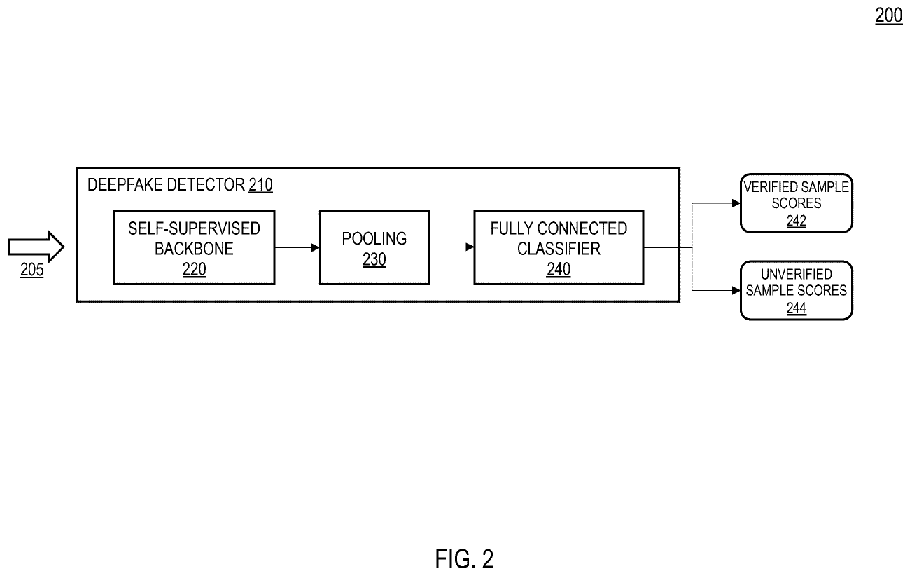

FIG. 2 illustrates an example 200 of a deepfake detector 210 that can be used in the deepfake detection system 100, in accordance with various embodiments. In particular, the deepfake detector 210 can be the deepfake detector 140 in the deepfake detection system 100. The deepfake detector 210 receives an audio input 205. The input 205 can be pre-processed, such as by a signal pre-processing block 120. Additionally, the input 205 may have been processed at a windowing block, such as the windowing module 130 of FIG. 1. The deepfake detector 210 includes a self-supervised backbone 220. The self-supervised backbone 220 is a component of a neural network, and the self-supervised backbone 220 extracts features from the input 205. According to various examples, feature extractors generally output several embeddings proportional to the length of the input. In some examples, the self-supervised backbone 220 converts the input 205 to an embedding, such as a high-dimensional embedding that captures phonetic characteristics, prosodic characteristics, and other speaker characteristics of the input. In some examples, the self-supervised backbone 220 outputs a sequence of frame-level features. In some examples, the self-supervised backbone 220 can be an encoder such as a Wav2Vec2 encoder, a WavLM encoder, or a Whisper encoder.

After extracting features, the embeddings may be pooled before passing through a classifier head to estimate the likelihood of being fake. The features output from the self-supervised backbone 220 are input to a pooling block 230, which can perform temporal average pooling to reduce the features over time and generate a fixed-dimensional embedding. The embedding is input to a fully connected (FC) classifier 240. The classifier 240 can include multiple linear layers with rectified linear unit (ReLU) activations. In one example, the classifier 240 includes three linear layers with LeakyReLU activations. The classifier 240 generates a deepfake score for the input sample.

According to some implementations, the deepfake detector 210 illustrates one embodiment of the deepfake detector 140 of FIG. 1. According to other implementations, the deepfake detector 140 can include any selected architecture. For example, the deepfake detector 140 can include an architecture that includes multi-layer feature fusion. In another example, the deepfake detector 140 can include an architecture that applies learned weights across intermediate features. In another example, the deepfake detector 140 can include an architecture that includes multiple parallel classifier heads and late score averaging.

### Example Data Using the Deepfake Detection System

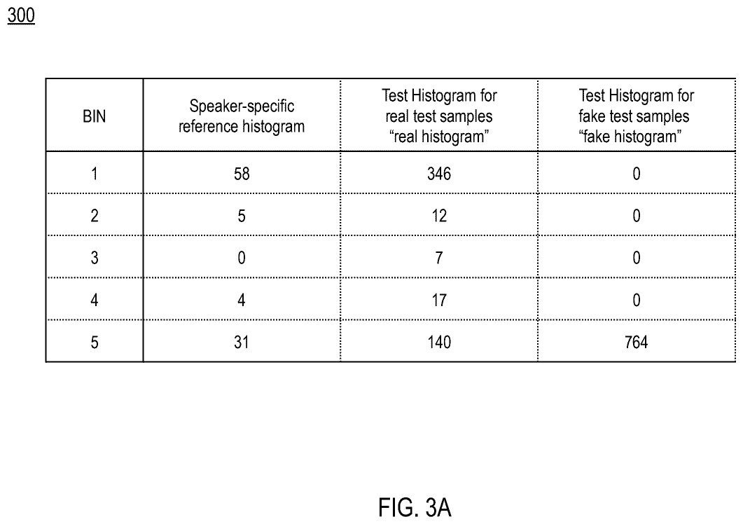

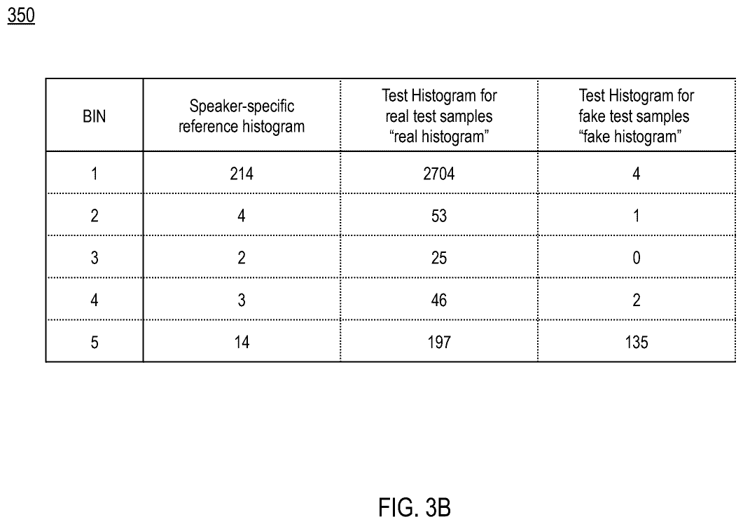

FIGS. 3A-3B illustrate tables 300, 350 showing a distribution of deepfake detection scores, binned into five equal-width intervals, for selected speakers, in accordance with various embodiments. In particular, a dataset was used that includes real (i.e., authentic) and fake (i.e., synthetic) audio files for public figures collected from publicly available sources such as social networks.

For FIG. 3A, speaker data for one selected speaker (Ronald Reagan) was used to generate the data shown in table 300. The first column labels the bin numbers—the histogram has five bins of equal width to cover the score range [0, . . . ,1], with each row of the table corresponding to a bin, indexed 1-5. The table then includes three columns of histogram counts (columns 2 through 4). The second columns shows the speaker-specific reference histogram counts determined from real training samples for the selected speaker. The third column shows the histogram counts for verified authentic test samples (“real histogram”). The fourth column shows the histogram counts for fake test samples (“fake histogram”). For each bin, the table 300 reports the number of samples whose deepfake detection scores (e.g., scores from a deepfake detector such as the deepfake detector 140) fall within the bin's range.

The table 300 demonstrates that, while the distribution of scores for real test samples closely matches that of the reference histogram, the distribution for fake test samples is quite different, with the majority of fake samples concentrated in the highest score bin (bin 5). The differences in the distributions supports the effectiveness of the disclosed techniques. In particular, statistical comparison of speaker-specific score distributions allows for reliable discrimination between authentic and fake (i.e., synthetic) audio samples.

For FIG. 3B, speaker data for another selected speaker (Donald Trump) was used to generate the data shown in table 350. The first column labels the bin numbers—the histogram has five bins of equal width to cover the score range [0, . . . ,1], with each row of the table corresponding to a bin, indexed 1-5. The table then includes three columns of histogram counts (columns 2 through 4). The second columns shows the speaker-specific reference histogram counts determined from real training samples for the selected speaker. The third column shows the histogram counts for verified authentic test samples (“real histogram”). The fourth column shows the histogram counts for fake test samples (“fake histogram”). For each bin, the table 350 reports the number of samples whose deepfake detection scores (e.g., scores from a deepfake detector such as the deepfake detector 140) fall within the bin's range.

The table 350 demonstrates that, for the selected speaker, the distribution of scores for authentic test samples closely matches that of the reference histogram, with the majority of authentic samples concentrated in the lowest score bin (bin 1). In contrast, the fake test samples are predominantly found in the highest score bin (bin 5). The difference between the distributions for the authentic samples and the fake samples contributes to the effectiveness of the systems and methods presented herein, in which statistical comparison of speaker-specific score distributions allows for reliable discrimination between authentic and fake audio samples.

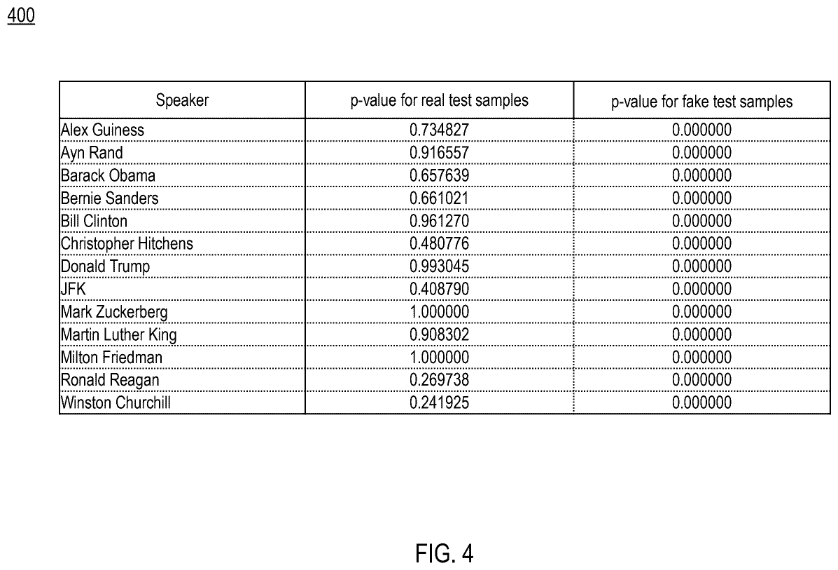

FIG. 4 shows a table 400 illustrating the results of statistical hypothesis testing on speaker-specific deepfake score distributions for multiple speakers, in accordance with various embodiments. For each speaker listed in the first column, two chi-square tests of independence were conducted: one comparing the speaker-specific reference histogram (constructed from real training samples) to the histogram of real test samples, and one comparing the speaker-specific reference histogram to the histogram of fake test samples. The second column in the table 400 shows the p-value for real test samples (indicating the statistical similarity between the reference and real test sample distributions). The third column in the table 400 shows the p-value for fake test samples (indicating the statistical similarity between the reference and fake test sample distributions). Using a significance level of 0.05, a p-value less than 0.05 is interpreted as a statistically significant difference between two histograms. As shown in table 400, the real test samples have a p-value greater than 0.05, indicating no statistically significant difference between the reference and real distributions. In contrast, the fake test samples have a p-value less than 0.05, indicating a statistically significant difference between the reference and fake distributions. The results demonstrate that, for all speakers, the statistical test does not detect a significant difference between the reference and real test sample distributions (all p-values >0.05), while it does detect a significant difference between the reference and fake test sample distributions (all p-values <0.05). The results confirms the effectiveness of systems and methods presented herein, such as the deepfake detection system 100, in distinguishing authentic from fake audio samples using speaker-specific statistical analysis.

### Example Method for Deepfake Detection

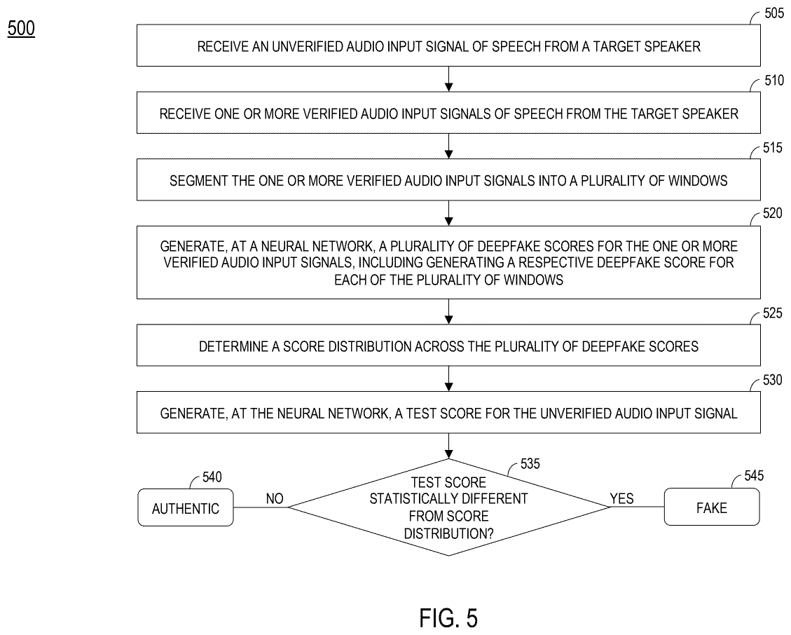

FIG. 5 shows a flowchart illustrating an example method 500 of deepfake detection, in accordance with various embodiments. The method 500 provides a speaker-specific approach for detecting whether an audio input signal is authentic or a deepfake, without retraining or modification of a pretrained deepfake detection model. Although the method 500 is described with reference to the flowchart illustrated in FIG. 5, many other methods for voice transformation may alternatively be used. For example, the order of execution of the elements in FIG. 5 may be changed. As another example, some of the steps may be changed, eliminated, or combined. In various examples, the method 500 can be implemented by a deepfake detection system, such as the deepfake detection system 100 of FIG. 1.

At 505, an unverified audio input signal of speech purportedly from a target speaker is received. At step 510, one or more verified audio input signals of speech from the same target speaker are also received. In some examples, the verified audio input signals can be used to generate reference data for subsequent statistical analysis.

At 515, the one or more verified audio input signals are segmented into a plurality of windows. The segmentation may include overlapping or non-overlapping windows. Additionally, the one or more verified audio input signals may undergo pre-processing operations such as normalization and/or bandpass filtering. In some examples, augmentation may be performed on the segmented data represented by the plurality of windows to increase the diversity and robustness of the reference set.

At 520, a plurality of deepfake scores for the verified audio input signals is generated at a neural network. In some examples, a neural network-based deepfake detection model, which is pretrained and speaker-independent, is used to generate the deepfake scores. According to some examples, a respective deepfake score is generated for each window of the plurality of windows, resulting in a set of deepfake scores that characterizes the target speaker's authentic speech.

At 525, a score distribution is determined across the plurality of deepfake scores for the verified audio input. In some examples, the score distribution may be estimated using parametric or non-parametric statistical methods, such as fitting a Gaussian model or constructing a histogram, to represent the expected range and likelihood of scores for authentic speech from the target speaker.

At 530, a test score for the unverified audio input signal is generated at a neural network. In particular, in some examples, the neural network-based deepfake detection model can be used to generate the test score. In some examples, the unverified audio input signal can be segmented into frames, each frame can be scored, and the scores can be aggregated. In some examples, aggregating the per window test scores can include using average, median, trimmed mean, or other aggregation functions. In some examples, the unverified audio input signal can be input directing to the neural network for processing.

At 535, it is determined whether the test score for the unverified audio input signal is statistically different from the reference score distribution for the verified audio input signals. In some examples, a statistical hypothesis test can be used to determine whether the unverified audio input signal is statistically different from the reference score distribution for the verified audio input signals. Examples of statistical hypothesis tests include a z-test, chi-square test, or other appropriate statistical distance measure, to determine whether the test score is consistent with the distribution of scores from the verified samples

At 535, if the test score is not statistically different from the reference score distribution (i.e., the null hypothesis cannot be rejected), the method 500 proceeds to 540 and classifies the unverified audio input signal as authentic. If, however, at 535, the test score is statistically different from the reference score distribution (i.e., the null hypothesis is rejected), the method 500 proceeds to 545 and classifies the unverified audio input signal as fake.

Deepfake detection using the method 500 allows for the use of speaker-specific conditioning information for deepfake detection, leveraging verified samples of the target speaker to improve detection accuracy, without requiring retraining or modification of the underlying deepfake detection model.

### Example Deep Neural Network System

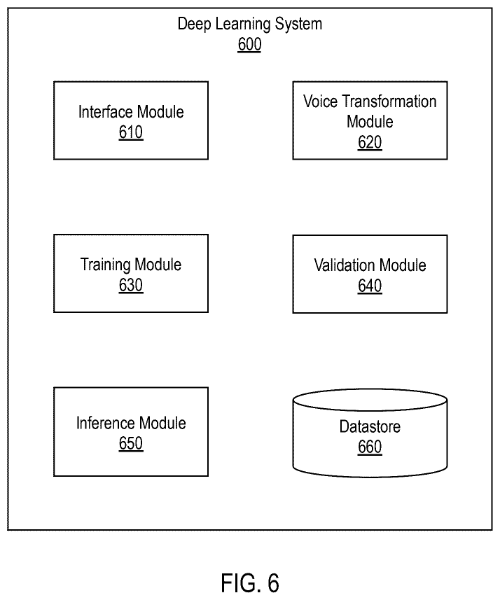

FIG. 6 is a block diagram of a deep learning system 600 that can be used for deepfake detection, in accordance with various embodiments. In some embodiments, the deep learning system 600 is a deep neural network (DNN). The deep learning system 600 trains DNNs for various tasks, including, for example, deepfake detection. In the embodiments of FIG. 6, the deep learning system 600 includes an interface module 610, a training module 630, a validation module 640, a deepfake detection module 620, and a datastore 660. In other embodiments, alternative configurations, different or additional components may be included in the deep learning system 600. Further, functionality attributed to a component of the deep learning system 600 may be accomplished by a different component included in the deep learning system 600 or a different module or system, such as any of the neural networks and/or deep learning systems described herein.

In some examples, the deep learning system 600 includes a lightweight model architecture that is both memory and compute efficient. The model can include a transformer-based model, a recurrent neural network (RNN), a convolutional neural network (CNN), or any other type of neural network.

The interface module 610 facilitates communications of the deep learning system 600 with other modules or systems. For example, the interface module 610 establishes communications between the deep learning system 600 with an external database to receive data that can be used to train DNNs or input into DNNs to perform tasks. As another example, the interface module 610 supports the deep learning system 600 to distribute DNNs to other systems, e.g., computing devices configured to apply DNNs to perform tasks.

The training module 630 trains DNNS by using a training dataset.

In an embodiment where the training module 630 trains a DNN to detect deepfakes, the training module 630 can compare features generated by the DNN to ground truth. In some embodiments, a part of the training dataset may be used to initially train the DNN, and the rest of the training dataset may be held back as a validation subset used by the validation module 640 to validate performance of a trained DNN. The portion of the training dataset not including the tuning subset and the validation subset may be used to train the DNN.

The training module 630 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 3, 30, 300, 400, or even larger.

The training module 630 defines the architecture of the DNN, e.g., based on some of the hyperparameters. In some examples, the architecture of the DNN includes multiple layers, such as an input layer, an output layer, and a plurality of hidden layers. The input layer of an DNN may include tensors (e.g., a multidimensional array) specifying attributes of the input signal, such as frequency, volume, and other spectral characteristics. The hidden layers are layers between the input layer and output layer. The hidden layers include one or more GRU (Gated Recurrent Unit) layers and one or more other types of layers, such as fully connected layers, convolutional layers, pooling layers, normalization layers, softmax or logistic layers, and so on. In some examples, GRU layers or convolutional layers of the DNN abstract the input signals to perform feature extraction. In some examples, the feature extraction is based on a spectrogram of an input sound signal. A pooling layer can be used to reduce the volume of input signal after convolution. It is used between two convolution layers. A fully connected layer involves weights, biases, and neurons. It connects neurons in one layer to neurons in another layer. It is used to classify signals between different categories by training. Note that training a DNN is different from using the DNN in real-time and when using a DNN to process data that is received in real-time, latency can become an issue that is not present during training, when the data set can be pre-loaded.

In the process of defining the architecture of the DNN, the training module 630 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 630 defines the architecture of the DNN, the training module 630 inputs a training dataset into the DNN. The training dataset includes a plurality of training samples. An example of a training sample includes source location of a feature in an audio sample and a ground-truth location of the feature. The training module 630 modifies the parameters inside the DNN (“internal parameters of the DNN”) to minimize the error between labels of the training features that are generated by the DNN and the ground-truth labels of the features. The internal parameters include weights of filters in the convolutional layers of the DNN. In some embodiments, the training module 630 uses a cost function to minimize the error.

The training module 630 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 630 finishes the predetermined number of epochs, the training module 630 may stop updating the parameters in the DNN. The DNN having the updated parameters is referred to as a trained DNN.

The validation module 640 verifies accuracy of trained or compressed DNNs. In some embodiments, the validation module 640 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 640 may determine an accuracy score measuring the precision, recall, or a combination of precision and recall of the DNN. The validation module 640 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 640 may compare the accuracy score with a threshold score. In an example where the validation module 640 determines that the accuracy score of the augmented model is less than the threshold score, the validation module 640 instructs the training module 630 to re-train the DNN. In one embodiment, the training module 630 may iteratively re-train the DNN until the occurrence of a stopping condition, such as the accuracy measurement indication that the DNN may be sufficiently accurate, or a number of training rounds having taken place.

The inference module 650 applies the trained or validated DNN to perform tasks. The inference module 650 may run inference processes of a trained or validated DNN. In some examples, inference makes use of the forward pass to produce model-generated output for unlabeled real-world data. For instance, the inference module 650 may input real-world data into the DNN and receive an output of the DNN. The output of the DNN may provide a solution to the task for which the DNN is trained for.

The inference module 650 may aggregate the outputs of the DNN to generate a final result of the inference process. In some embodiments, the inference module 650 may distribute the DNN to other systems, e.g., computing devices in communication with the deep learning system 600, for the other systems to apply the DNN to perform the tasks. The distribution of the DNN may be done through the interface module 610. The computing devices may be connected to the deep learning system 600 through a network.

In some implementations, the DNN may include a convolution module. In some examples, the convolution module can also perform additional real-time data processing, such as for speech enhancement, and/or dynamic noise suppression. The convolution module can include the deepfake detection module. In other embodiments, alternative configurations, different or additional components may be included in the convolution module. Further, functionality attributed to a component of the convolution module may be accomplished by a different component included in the convolution module, the deep learning system 600, or a different module or system.

In various examples, a Short-Time Fourier Transform (STFT) is a Fourier-related transform used to determine the sinusoidal frequency and phase content of local sections of a signal as it changes over time. Generally, STFTs are computed by dividing a longer time signal into shorter segments of equal length and then computing the Fourier transform separately on each shorter segment. This results in the Fourier spectrum on each shorter segment. The changing spectra can be plotted as a function of time, for instance as a spectrogram. In some examples, the STFT is a discrete time STFT, such that the data to be transformed is broken up into tensors or frames (which usually overlap each other, to reduce artifacts at the boundary). Each tensor or frame is Fourier transformed, and the complex result is added to a matrix, which records magnitude and phase for each point in time and frequency. In some examples, an input tensor has a size of H×W×C, where H denotes the height of the input tensor (e.g., the number of rows in the input tensor or the number of data elements in a row), W denotes the width of the input tensor (e.g., the number of columns in the input tensor or the number of data elements in a row), and C denotes the depth of the input tensor (e.g., the number of input channels).

An inverse STFT can be generated by inverting the STFT. In various examples, the STFT is processed by the DNN, and it is then inverted at the decoder, or before being input to the decoder. By inverting the STFT, the encoded frequency domain signal from the frequency encoder can be recombined with the encoded time domain signal from the time encoder. One way of inverting the STFT is by using the overlap-add method, which also allows for modifications to the STFT complex spectrum. This makes for a versatile signal processing method, referred to as the overlap and add with modifications method. In various examples, the output from the decoder is an audio output signal representing the input signal for a selected audio source. In some examples, the output from the decoder includes multiple separated audio output signals, each representing the input signal for a respective input audio source.

The datastore 660 stores data received, generated, used, or otherwise associated with the deep learning system 600. For example, the datastore 660 stores the datasets used by the training module 630 and validation module 640. The datastore 660 may also store data such as the hyperparameters for training DNNs, internal parameters of trained DNNs (e.g., weights, etc.), data for sparsity acceleration (e.g., sparsity bitmap, etc.), and so on. In some embodiments the datastore 660 is a component of the deep learning system 600. In other embodiments, the datastore 660 may be external to the deep learning system 600 and communicate with the deep learning system 600 through a network.

### Example Computing Device

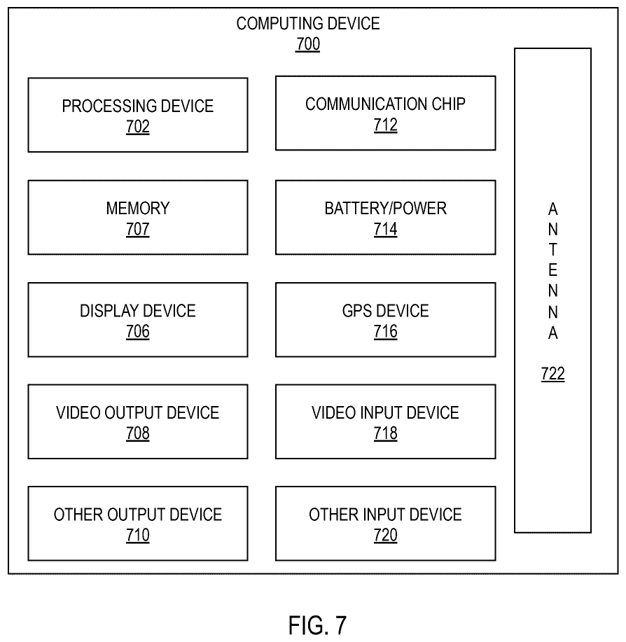

FIG. 7 is a block diagram of an example computing device 700, in accordance with various embodiments. In some embodiments, the computing device 700 may be used for at least part of the systems in FIGS. 1, 2, and 5. A number of components are illustrated in FIG. 7 as included in the computing device 700, but any one or more of these components may be omitted or duplicated, as suitable for the application. In some embodiments, some or all of the components included in the computing device 700 may be attached to one or more motherboards. In some embodiments, some or all of these components are fabricated onto a single system on a chip (SoC) die. Additionally, in various embodiments, the computing device 700 may not include one or more of the components illustrated in FIG. 7, but the computing device 700 may include interface circuitry for coupling to the one or more components. For example, the computing device 700 may not include a display device 706, but may include display device interface circuitry (e.g., a connector and driver circuitry) to which a display device 706 may be coupled. In another set of examples, the computing device 700 may not include a video input device 718 or a video output device 708, but may include video input or output device interface circuitry (e.g., connectors and supporting circuitry) to which a video input device 718 or video output device 708 may be coupled.

The computing device 700 may include a processing device 702 (e.g., one or more processing devices). The processing device 702 processes electronic data from registers and/or memory to transform that electronic data into other electronic data that may be stored in registers and/or memory. The computing device 700 may include a memory 704, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 704 may include memory that shares a die with the processing device 702. In some embodiments, the memory 704 includes one or more non-transitory computer-readable media storing instructions executable for occupancy mapping or collision detection, e.g., the method 500 described above in conjunction with FIG. 5 or some operations performed by the system 100 of FIG. 1, the DNN system 600 in FIG. 6, and/or any other systems discussed herein. The instructions stored in the one or more non-transitory computer-readable media may be executed by the processing device 702.

In some embodiments, the computing device 700 may include a communication chip 712 (e.g., one or more communication chips). For example, the communication chip 712 may be configured for managing wireless communications for the transfer of data to and from the computing device 700. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 712 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 512 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 512 may operate in accordance with other wireless protocols in other embodiments. The computing device 700 may include an antenna 722 to facilitate wireless communications and/or to receive other wireless communications (such as AM or FM radio transmissions).

In some embodiments, the communication chip 712 may manage wired communications, such as electrical, optical, or any other suitable communication protocols (e.g., the Ethernet). As noted above, the communication chip 712 may include multiple communication chips. For instance, a first communication chip 712 may be dedicated to shorter-range wireless communications such as Wi-Fi or Bluetooth, and a second communication chip 712 may be dedicated to longer-range wireless communications such as global positioning system (GPS), EDGE, GPRS, CDMA, WiMAX, LTE, EV-DO, or others. In some embodiments, a first communication chip 712 may be dedicated to wireless communications, and a second communication chip 712 may be dedicated to wired communications.

The computing device 700 may include battery/power circuitry 714. The battery/power circuitry 714 may include one or more energy storage devices (e.g., batteries or capacitors) and/or circuitry for coupling components of the computing device 700 to an energy source separate from the computing device 700 (e.g., AC line power).

The computing device 700 may include a display device 706 (or corresponding interface circuitry, as discussed above). The display device 706 may include any visual indicators, such as a heads-up display, a computer monitor, a projector, a touchscreen display, a liquid crystal display (LCD), a light-emitting diode display, or a flat panel display, for example.

The computing device 700 may include a video output device 708 (or corresponding interface circuitry, as discussed above). The video output device 708 may include any device that generates an audible indicator, such as speakers, headsets, or earbuds, for example.

The computing device 700 may include a video input device 718 (or corresponding interface circuitry, as discussed above). The video input device 718 may include any device that generates a signal representative of a sound, such as microphones, microphone arrays, or digital instruments (e.g., instruments having a musical instrument digital interface (MIDI) output).

The computing device 700 may include a GPS device 716 (or corresponding interface circuitry, as discussed above). The GPS device 716 may be in communication with a satellite-based system and may receive a location of the computing device 700, as known in the art.

The computing device 700 may include another output device 710 (or corresponding interface circuitry, as discussed above). Examples of the other output device 710 may include a video codec, a video codec, a printer, a wired or wireless transmitter for providing information to other devices, or an additional storage device.

The computing device 700 may include another input device 720 (or corresponding interface circuitry, as discussed above). Examples of the other input device 720 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 700 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 700 may be any other electronic device that processes data.

### Select Examples

Example 1 provides an apparatus, including a computer processor for executing computer program instructions; and a non-transitory computer-readable memory storing computer program instructions executable by the computer processor to perform operations including receiving an unverified audio input signal of speech from a target speaker; receiving one or more verified audio input signals of speech from the target speaker; segmenting the one or more verified audio input signals into a plurality of windows; generating, at a neural network, a plurality of deepfake scores for the one or more verified audio input signals, including generating a respective deepfake score for each of the plurality of windows; determining a score distribution across the plurality of deepfake scores; generating, at the neural network, a test score for the unverified audio input signal; and determining, based on the test score and the score distribution, that the unverified audio input signal is one of authentic or fake.

Example 2 provides the apparatus of example 1, where the operations further include determining a statistical test value representing a difference between the test score and the score distribution.

Example 3 provides the apparatus of example 2, where determining that the unverified audio input signal is authentic includes determining that the statistical test value is less than a selected threshold.

Example 4 provides the apparatus of any of examples 2-3, where determining that the unverified audio input signal is fake includes determining that the statistical test value is greater than a selected threshold.

Example 5 provides the apparatus of examples 3-4, where the selected threshold is a speaker-specific threshold computed from at least one parameter of the score distribution, where the at least one parameter includes a mean, variance, quantile, and/or percentile.

Example 6 provides the apparatus of any of examples 1-5, where determining the score distribution includes fitting a parametric probability distribution to the plurality of deepfake scores.

Example 7 provides the apparatus of of examples 1-6, where the plurality of windows is a plurality of first windows, and where the operations further include augmenting the plurality of first windows to generate a plurality of augmented windows including variations of each of the plurality of first windows.

Example 8 provides the apparatus of example 7, where augmenting the plurality of first windows includes applying at least one of: additive white Gaussian noise, room impulse response convolution, codec compression, and resampling.

Example 9 provides the apparatus of any of examples 1-8, where the neural network is a pretrained, speaker-independent deepfake detector.

Example 10 provides the apparatus of any of examples 1-9, where segmenting the one or more verified audio input signals into a plurality of windows includes sliding-window segmentation and the plurality of windows include a plurality of overlapping windows.

Example 11 provides the apparatus of any of examples 1-10, where determining the score distribution further includes determining a non-parametric estimate selected from a histogram, a kernel density estimate, or an empirical cumulative distribution function.

Example 12 provides the apparatus of any of examples 1-11, where the operations further include calibrating deepfake scores prior to determining that the unverified audio input signal is one of authentic or fake.

Example 13 provides the apparatus of any of examples 1-12, where the operations further include pre-processing the one or more verified audio input signals and the unverified audio input signal by at least one of: signal standardization, band pass filtering, amplitude normalization, random power scaling and fixed power normalization.

Example 14 provides the apparatus of any of examples 1-13, where generating the test score for the unverified audio input signal includes windowing the unverified audio input signal into second windows and aggregating per window test scores.

Example 15 provides one or more non-transitory computer-readable media storing instructions executable to perform operations, the operations including receiving an unverified audio input signal of speech from a target speaker; receiving one or more verified audio input signals of speech from the target speaker; segmenting the one or more verified audio input signals into a plurality of windows; generating, at a neural network, a plurality of deepfake scores for the one or more verified audio input signals, including generating a respective deepfake score for each of the plurality of windows; determining a score distribution across the plurality of deepfake scores; generating, at the neural network, a test score for the unverified audio input signal; and determining, based on the test score and the score distribution, that the unverified audio input signal is one of authentic or fake.

Example 16 provides the one or more non-transitory computer-readable media of example 15, where the operations further include determining a statistical test value representing a difference between the test score and the score distribution.

Example 17 provides the one or more non-transitory computer-readable media of example 16, where determining that the unverified audio input signal is authentic includes determining that the statistical test value is less than a selected threshold.

Example 18 provides the one or more non-transitory computer-readable media of examples 16-17, where determining that the unverified audio input signal is fake includes determining that the statistical test value is greater than a selected threshold.

Example 19 provides the one or more non-transitory computer-readable media of any of examples 17-18, where the selected threshold is a speaker-specific threshold computed from at least one parameter of the score distribution, where the at least one parameter includes a mean, variance, quantile, and/or percentile.

Example 20 provides the one or more non-transitory computer-readable media of any of examples 15-19, where determining the score distribution includes fitting a parametric probability distribution to the plurality of deepfake scores.

Example 21 provides the one or more non-transitory computer-readable media of any of examples 15-20, where the plurality of windows is a plurality of first windows, and where the operations further include augmenting the plurality of first windows to generate a plurality of augmented windows including variations of each of the plurality of first windows.

Example 22 provides the one or more non-transitory computer-readable media of example 21, where augmenting the plurality of first windows includes applying at least one of: additive white Gaussian noise, room impulse response convolution, codec compression, and resampling.

Example 23 provides the one or more non-transitory computer-readable media of any one of examples 15-22, where the neural network is a pretrained, speaker-independent deepfake detector.

Example 24 provides the one or more non-transitory computer-readable media of any one of examples 15-23, where segmenting the one or more verified audio input signals into a plurality of windows includes sliding-window segmentation and the plurality of windows include a plurality of overlapping windows.

Example 25 provides the one or more non-transitory computer-readable media of any one of examples 15-24, where determining the score distribution further includes determining a non-parametric estimate selected from a histogram, a kernel density estimate, or an empirical cumulative distribution function.

Example 26 provides the one or more non-transitory computer-readable media of any of examples 15-25, where the operations further include calibrating deepfake scores prior to determining that the unverified audio input signal is one of authentic or fake.

Example 27 provides the one or more non-transitory computer-readable media of any of examples 15-26, where the operations further include pre-processing the one or more verified audio input signals and the unverified audio input signal by at least one of: signal standardization, band pass filtering, amplitude normalization, random power scaling and fixed power normalization.

Example 28 provides the one or more non-transitory computer-readable media of any of examples 15-27, where generating the test score for the unverified audio input signal includes windowing the unverified audio input signal into second windows and aggregating per window test scores.

Example 29 provides a computer-implemented method for deepfake detection, including receiving an unverified audio input signal of speech from a target speaker; receiving one or more verified audio input signals of speech from the target speaker; segmenting the one or more verified audio input signals into a plurality of windows; generating, at a neural network, a plurality of deepfake scores for the one or more verified audio input signals, including generating a respective deepfake score for each of the plurality of windows; determining a score distribution across the plurality of deepfake scores; generating, at the neural network, a test score for the unverified audio input signal; and determining, based on the test score and the score distribution, that the unverified audio input signal is one of authentic or fake.

Example 30 Provides the Computer-implemented method of example 29, where the operations further include determining a statistical test value representing a difference between the test score and the score distribution.

Example 31 provides the computer-implemented method of example 30, where determining that the unverified audio input signal is authentic includes determining that the statistical test value is less than a selected threshold.

Example 32 provides the computer-implemented method of any of examples 30-31, where determining that the unverified audio input signal is fake includes determining that the statistical test value is greater than a selected threshold.

Example 33 provides the computer-implemented method of examples 31-32, where the selected threshold is a speaker-specific threshold computed from at least one parameter of the score distribution, where the at least one parameter includes a mean, variance, quantile, and/or percentile.

Example 34 provides the computer-implemented method of any of examples 29-33, where determining the score distribution includes fitting a parametric probability distribution to the plurality of deepfake scores.

Example 35 provides the computer-implemented method of any of examples 29-34, where the plurality of windows is a plurality of first windows, and where the operations further include augmenting the plurality of first windows to generate a plurality of augmented windows including variations of each of the plurality of first windows.

Example 36 provides the computer-implemented method of example 35, where augmenting the plurality of first windows includes applying at least one of: additive white Gaussian noise, room impulse response convolution, codec compression, and resampling.

Example 37 provides the computer-implemented method of any of examples 29-36, where the neural network is a pretrained, speaker-independent deepfake detector.

Example 38 provides the computer-implemented method of any of examples 29-37, where segmenting the one or more verified audio input signals into a plurality of windows includes sliding-window segmentation and the plurality of windows include a plurality of overlapping windows.

Example 39 provides the computer-implemented method of any of examples 29-38, where determining the score distribution further includes determining a non-parametric estimate selected from a histogram, a kernel density estimate, or an empirical cumulative distribution function.

Example 40 provides the computer-implemented method of any of examples 29-39, where the operations further include calibrating deepfake scores prior to determining that the unverified audio input signal is one of authentic or fake.

Example 41 provides the computer-implemented method of any of examples 29-40, where the operations further include pre-processing the one or more verified audio input signals and the unverified audio input signal by at least one of: signal standardization, band pass filtering, amplitude normalization, random power scaling and fixed power normalization.

Example 42 provides the computer-implemented method of any of examples 29-41, where generating the test score for the unverified audio input signal includes windowing the unverified audio input signal into second windows and aggregating per window test scores.

Example A provides an apparatus comprising means to carry out or means for carrying out any one of the methods provided in examples 29-42 and methods/processes described herein.

Example B provides deepfake detector as described herein.

### Variations and Other Notes

Although the operations of the example method shown in and described with reference to FIGS. 1-7 are illustrated as occurring once each and in a particular order, it will be recognized that the operations may be performed in any suitable order and repeated as desired. Additionally, one or more operations may be performed in parallel. Furthermore, the operations illustrated in FIGS. 1-9 may be combined or may include more or fewer details than described.

The various implementations described herein may refer to artificial intelligence, machine learning, and deep learning. Machine learning may be a subset of artificial intelligence. Deep learning may be a subset of machine learning. In cases where a deep learning model is mentioned, if suitable for a particular application, a different kind of machine learning model may be used instead. In cases where a deep learning model is mentioned, if suitable for a particular application, a different kind of artificial intelligence model may be used instead. In cases where a deep learning model, machine learning model, or an artificial intelligence model is mentioned, if suitable for a particular application, a digital signal processing system may be used instead.

Various models can be trained using training data, or in an unsupervised manner. Parameters of the model (e.g., parameters in background models, foreground object models, neural networks, etc.) may be updated during the training process, or through unsupervised learning.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

What is claimed is:

1. An apparatus, comprising:
a computer processor for executing computer program instructions; and
a non-transitory computer-readable memory storing computer program instructions executable by the computer processor to perform operations comprising:
receiving an unverified audio input signal of speech from a target speaker;
receiving one or more verified audio input signals of speech from the target speaker;
segmenting the one or more verified audio input signals into a plurality of windows;
generating, at a neural network, a plurality of deepfake scores for the one or more verified audio input signals, including generating a respective deepfake score for each of the plurality of windows;
determining a score distribution across the plurality of deepfake scores;
generating, at the neural network, a test score for the unverified audio input signal; and
determining, based on the test score and the score distribution, that the unverified audio input signal is one of authentic or fake.

2. The apparatus of claim 1, wherein the operations further comprise determining a statistical test value representing a difference between the test score and the score distribution.

3. The apparatus of claim 2, wherein determining that the unverified audio input signal is authentic includes determining that the statistical test value is less than a selected threshold.

4. The apparatus of claim 2, wherein determining that the unverified audio input signal is fake includes determining that the statistical test value is greater than a selected threshold.

5. The apparatus of claim 1, wherein determining the score distribution comprises fitting a parametric probability distribution to the plurality of deepfake scores.

6. The apparatus of claim 1, wherein the plurality of windows is a plurality of first windows, and wherein the operations further comprise augmenting the plurality of first windows to generate a plurality of augmented windows including variations of each of the plurality of first windows.

7. The apparatus of claim 1, wherein the neural network is a pretrained, speaker-independent deepfake detection model.

8. The apparatus of claim 1, wherein segmenting the one or more verified audio input signals into a plurality of windows includes sliding-window segmentation and the plurality of windows include a plurality of overlapping windows.

9. One or more non-transitory computer-readable media storing instructions executable to perform operations, the operations comprising:
receiving an unverified audio input signal of speech from a target speaker;
receiving one or more verified audio input signals of speech from the target speaker;
segmenting the one or more verified audio input signals into a plurality of windows;
generating, at a neural network, a plurality of deepfake scores for the one or more verified audio input signals, including generating a respective deepfake score for each of the plurality of windows;
determining a score distribution across the plurality of deepfake scores;
generating, at the neural network, a test score for the unverified audio input signal; and
determining, based on the test score and the score distribution, that the unverified audio input signal is one of authentic or fake.

10. The one or more non-transitory computer-readable media of claim 9, wherein the operations further comprise determining a statistical test value representing a difference between the test score and the score distribution.

11. The one or more non-transitory computer-readable media of claim 10, wherein determining that the unverified audio input signal is authentic includes determining that the statistical test value is less than a selected threshold.

12. The one or more non-transitory computer-readable media of claim 10, wherein determining that the unverified audio input signal is fake includes determining that the statistical test value is greater than a selected threshold.

13. The one or more non-transitory computer-readable media of claim 9, wherein determining the score distribution comprises fitting a parametric probability distribution to the plurality of deepfake scores.

14. The one or more non-transitory computer-readable media of claim 9, wherein the plurality of windows is a plurality of first windows, and wherein the operations further comprise augmenting the plurality of first windows to generate a plurality of augmented windows including variations of each of the plurality of first windows.

15. The one or more non-transitory computer-readable media of claim 9, wherein the neural network is a pretrained, speaker-independent deepfake detection model.

16. The one or more non-transitory computer-readable media of claim 9, wherein segmenting the one or more verified audio input signals into a plurality of windows includes sliding-window segmentation and the plurality of windows include a plurality of overlapping windows.

17. A computer-implemented method for deepfake detection, comprising:
receiving an unverified audio input signal of speech from a target speaker;
receiving one or more verified audio input signals of speech from the target speaker;
segmenting the one or more verified audio input signals into a plurality of windows;
generating, at a neural network, a plurality of deepfake scores for the one or more verified audio input signals, including generating a respective deepfake score for each of the plurality of windows;
determining a score distribution across the plurality of deepfake scores;
generating, at the neural network, a test score for the unverified audio input signal; and
determining, based on the test score and the score distribution, that the unverified audio input signal is one of authentic or fake.

18. The computer-implemented method of claim 17, further comprising determining a statistical test value representing a difference between the test score and the score distribution.

19. The computer-implemented method of claim 18, wherein determining that the unverified audio input signal is authentic includes determining that the statistical test value is less than a selected threshold.

20. The computer-implemented method of claim 18, wherein determining that the unverified audio input signal is fake includes determining that the statistical test value is greater than a selected threshold.
